(19) United States
(12) Patent Application Publication
(10) Pub. No.: US 2020/0169793 A1
(43) Pub. Date: May 28, 2020

(54) METHODS AND NODES FOR PROVIDING MULTI PERSPECTIVE VIDEO OF MATCH EVENTS OF INTEREST

(71) Applicant: ZNIPE ESPORTS AB, Stockholm (SE)

(72) Inventor: Erik ÅKERFELDT, Sollentuna (SE)

(73) Assignee: ZNIPE ESPORTS AB, Stockholm (SE)

(21) Appl. No.: 16/604,478

(22) PCT Filed: Apr. 11, 2018
(86) PCT No.: PCT/SE2018/050369

§ 371 Date: Oct. 10, 2019

(30) Foreign Application Priority Data
Apr. 11, 2017 (SE) 1750436-6

(51) Int. Cl. H04N 21/8549; G06K 9/00; H04N 21/8547; H04N 21/2187; A63F 13/497; H04N 21/235; G06F 16/735; A63F 13/86; H04L 29/06; G06F 16/78; A63F 13/355; H04N 21/234; H04N 21/2343; G06F 16/9535

(52) U.S. Cl. CPC H04N 21/8549; A63F 2300/538; H04N 21/8547; H04N 21/2187; A63F 13/497; H04N 21/235; G06F 16/735; A63F 13/86; H04L 65/601; G06K 9/00724; G06F 16/7867; A63F 13/355; H04N 21/23418; H04N 21/2343; G06F 16/9535; A63F 2300/577; G06K 2009/00738; A63F 2300/634; G06K 9/00765

(57) ABSTRACT

A method performed by a server for providing highlights of an esports game from a server to a communications device. The method comprises connecting to a game server, rendering a plurality of video streams from the game server, and analyzing match metadata in order to find match events of interest. The method further comprises compiling a list of the events of interest, assigning an interest value to each event, determining relevant video segments of the video streams for each event of interest, and providing the relevant video segments to a communications device.

### TECHNICAL FIELD

The present invention relates methods and nodes for providing highlights from events, especially from events such as esports tournaments.

### BACKGROUND ART

Live streaming of events, especially sport events, has been happening for decades, and is especially common in connection with large happenings, such as the World Cup in Football or the Olympic Games.

Live streaming of gaming events, such as esports tournaments, is relatively speaking much younger, since computer games and esports have only started to gain major traction the last decade or two.

As is often the case, new phenomena brings its own set of challenges, and such is the case also with streaming and providing coverage of esports and gaming tournaments. For example, in computer games there are multiple interesting viewpoints, as opposed to only one or a few which is common in regular sports.

Technologies are becoming available where it is possible for a user to view multiple viewpoints from an esports match simultaneously. However, this entails new problems to be solved.

Traditionally in sports, and in esports (even though it is a much younger phenomenon), it is relevant to present highlights/events of interest from a match after it has been played, or even during the time it is being played. Providing such highlights to a user in an efficient way has traditionally been fairly straightforward, since there has only been one source to choose highlights from. However, with new streaming technologies, particularly ones comprising multiple available viewing perspectives, how such a highlight stream should be provided to a user is not obvious.

### SUMMARY OF INVENTION

An object of the present invention is to solve at least some of the problems outlined above. It is possible to achieve these objects and others by using devices and systems as defined in the attached independent claims.

According to a first aspect, there is provided a method performed by a streaming server of a communications network for providing of highlights of an esports game from a server to a communications device, the server comprising a plurality of software streaming clients. The method comprises connecting to a game server, the game server comprising match metadata and a plurality of video streams of different perspectives of the esports game and rendering the plurality of video streams from the game server, wherein each software streaming client renders a different video stream. The method further comprises analyzing the match metadata in order to find match events of interest in the esports match and compiling a list of match events of interest, and further assigning an interest value to each match event of interest in the complied list. The method further comprises determining relevant video segments of the video streams for each match event of interest and providing the relevant video segments to the communications device, wherein the providing comprises providing at least two relevant video segments for at least one match event of interest.

By using a method according to the present disclosure, it becomes possible to provide video of match events of interest of streaming comprising multiple perspective views in an efficient and synchronized manner.

According to an optional embodiment, the determining step is based on the match metadata. By having the determining step based on match metadata, a faster method maybe achieved which quickly identifies the relevant video segments.

According to an optional embodiment, each event of interest comprises timestamp data, each relevant video segment comprises timestamp data, and the determining step is based on the timestamp data. The determining step may be based on both timestamp data and on match metadata.

Further, in an optional embodiment the plurality of video streams and the corresponding rendered video streams also comprise timestamp data, and the step. The determining and/or the providing and/or the bundling steps may further be based on such timestamp data.

According to an optional embodiment, the method further comprises bundling the relevant video segments before providing them to the communications device. Such step may typically be based on timestamp data, such that the relevant video segments are provided in a bundle synchronized relative to a match time.

According to a second aspect, there is provided a streaming server for providing highlights of an esports match to a communications device, the server comprising a plurality of software streaming clients, an encoder for connecting to a game server comprising a plurality of video streams for a match, and for rendering the plurality of video streams on the plurality of software streaming clients and a processor (1010). The processor is adapted for analyzing the match metadata in order to find match events of interest in the esports match, compiling a list of match events of interest and assigning an interest value to each match event of interest in the complied list. The processor is further adapted for determining relevant video segments of the video streams for each match event of interest and providing the relevant video segments to the communications device, wherein the providing comprises providing at least two relevant video segments for at least one match event of interest.

According to an optional embodiment, the streaming server further comprises a bundling unit adapted for bundling video segments related to a same match event of interest together.

There are further optional embodiments of the second aspect corresponding to the optional embodiments of the first aspect.

The aspects and embodiments described above are freely combinable with each other. There are optional embodiments of the second, third, fourth, fifth and sixth aspects that correspond to the optional embodiments of the first aspect.

### BRIEF DESCRIPTION OF DRAWINGS

The solution will now be described more in detail, by way of example, with reference to the accompanying drawings, in which:

FIG. 1 shows a schematic diagram of providing a highlight stream to a client device in a traditional architecture.

FIG. 2 shows a schematic diagram of providing a highlight stream to a client device in a multi perspective architecture.

FIG. 3 shows a flow chart of a method according to the present disclosure.

FIG. 4 shows a server according to the present disclosure.

### DESCRIPTION OF EMBODIMENTS

In the following, a detailed description of the different embodiments of the solution is disclosed with reference to the accompanying drawings. All examples herein should be seen as part of the general description and are therefore possible to combine in any way in general terms.

Shortly described, the present solution relates to a solution for providing a multiple perspective highlight stream to a client device, particularly a multi perspective highlight stream related to an esports match. Examples of games which are suitable for such streaming include any game with more than one relevant perspective, such as e.g. Counter Strike, League of Legends, DotA 2 and Overwatch.

In a solution according to the present disclosure, match metadata from a multiple perspective stream of an esports match is analyzed in order to detect events of interest, such as important and/or spectacular kills and deaths, decisive rounds and similar. A list is compiled of all events of interest, and the events are ranked according to how important and/or interesting an event is deemed to be. Relevant video segments are determined for each event of interest, based on a plurality of available perspectives. The relevant video segments relating to a same event of interest are then bundled together and the bundle is provided to a client device.

Today, solutions are becoming available for providing streams of esports matches where multiple perspectives are being displayed to a viewer simultaneously. For example, a multiple perspective stream of an esports game may contain one perspective from each player in the game and an event stream, wherein the event stream may be based on the different player perspectives or it may have a unique perspective of its own. In such solutions with multiple perspectives, a viewer may typically choose which ones and/or how many of these perspectives that should be displayed simultaneously.

These new solutions with multiple perspectives makes it possible to provide media to users in new ways, which entails new possibilities as well as new problems. Traditional solutions for streaming typically comprise one stream for a particular match or event, and consequently events of interest, i.e. highlights, from a match only has one relevant source to consider. Thus, the problem of providing relevant video segments for a particular event of interest in such traditional streaming is straightforward, but it lacks variety and options to choose from.

Streaming solutions comprising multiple different perspectives of a particular match are subject to the problem of how to present a stream of highlights, i.e. match events of interest, to a user, in an appealing and efficient way. For any particular event of interest, there are likely to be multiple perspectives that may be relevant and/or interesting for a viewer to see.

For example, consider the case of an ongoing match of Counter Strike: Global Offensive. Suppose that there is an event in which one player in a team kills all five players of the other team. The perspective of the player doing all of the kills will definitely be considered a relevant viewpoint. The perspective of some, or all, of the players getting killed may also be relevant for a viewer. Furthermore, perspectives of some of the teammates of the player doing the kills may also be relevant, even if they didn't engage in the fight by themselves, since they may have been watching from an interesting viewpoint or similar.

As illustrated by this example, there may be multiple relevant views to present to a viewer from any particular event of interest. As will be understood, this may be applicable to any solution for streaming of a match that comprises several different perspectives that may be relevant to present to a viewer.

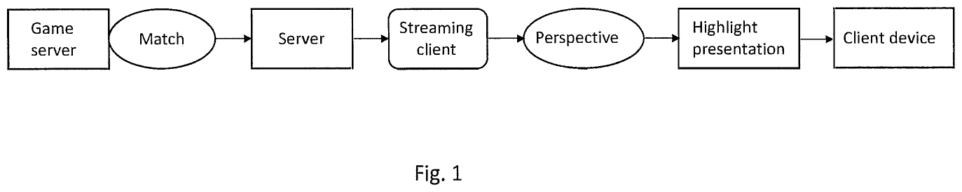

Looking now at FIG. 1, a traditional solution for providing highlights to a user is shown. A match for which highlights are to be provided is being played on a game server. A streaming server connects to the game server in order to render the game on a different platform, from which a streaming client streams the video and audio of the game to a user. The user is shown one perspective, which is typically the only available perspective. After the game has been finished, or during the game, events of interest are determined that are to be presented to a user on a client device. Since there is only one stream to choose from, the relevant video segments for each determined event of interest are easily located, and the highlights may be provided to a client device for viewing.

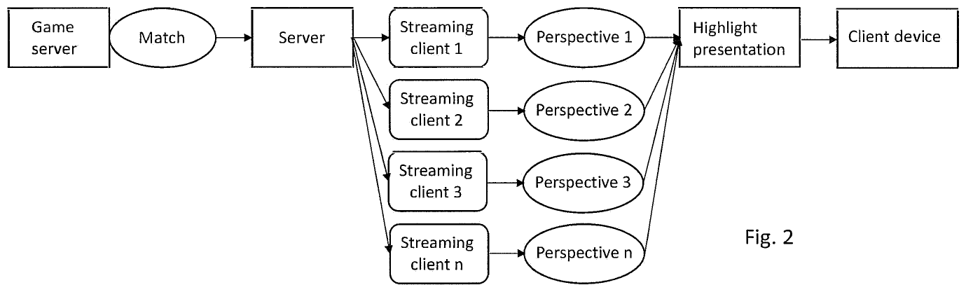

Looking now at FIG. 2, a solution according to the present disclosure is presented schematically. As can be seen, key differences are that the streaming server now comprises a plurality of streaming clients, each of which will present a perspective out of a plurality of available perspectives, and that each of these perspectives of a match being played are rendered on the server and may be presented to the user. This entails that, after a game has been finished and highlights are to be presented to a viewer, this solution has vastly more available video streams, i.e. available perspectives, to choose from when determining which highlights to present to a user, compared to traditional solutions.

How to determine which highlights are relevant, and how to present these, is not a straightforward problem in the same way it is for the traditional solutions comprising only one stream of a given match. For example, some questions that arise include how to provide highlights from different perspectives relating to a same event. Should highlights from each perspective view be presented sequentially, or should they be displayed simultaneously for each event of interest? Should all available views be presented for each event of interest such that the user has to keep track of which perspectives are relevant for each event of interest, or should only certain views be presented for each event? Should the video from each available perspective be analyzed in order to determine if the stream is relevant for each match event of interest, or should the events of interest be determined based on other factors? Should all the video be provided to the user who can then choose to play only the relevant segments, or should only the relevant segments be provided to the user?

As can be seen, there are several questions that arise when trying to solve the problem of how to provide a highlight stream from a multiple perspective stream to a user. The present disclosure provides a solution for achieving this.

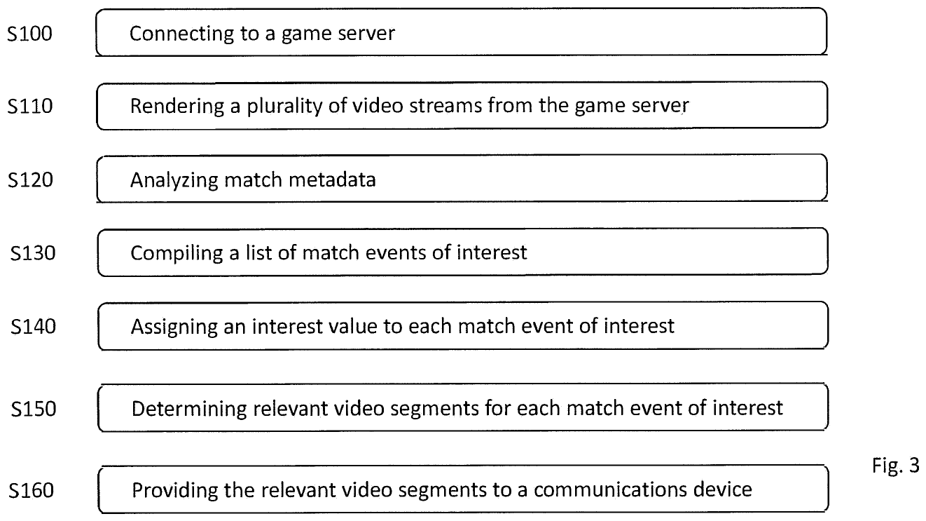

Looking now at FIG. 3, the steps of a method according to the present disclosure will now be described. The method in FIG. 3 is performed by a server, denoted streaming server, typically comprising a plurality of software streaming clients. The server is in some embodiments a cloud server hosted in a cloud environment.

In a first step S110, the streaming server connects to a game server. The game server is a server hosting an ongoing match of a game, and/or a server hosting a game that has already been played. An ongoing game hosted on a game server has a plurality of perspective views available, each perspective view represented by a video stream. By connecting to the game server, the streaming server gets access to the video for each perspective view available. Typically, the game server comprises at least one perspective view for each player in the match.

In a second step S110, the video from the game server is rendered onto the streaming server. Typically the game server will host the match in a format only accessible via a game platform, and not accessible from e.g. web browsers. By rendering the video onto the streaming server, it becomes more accessible to users. The streaming server renders the same video as is being shown in the game server, typically without modification. In some embodiments, the rendering step may comprise adding information such as a watermark in order to identify the company performing the rendering, and/or in order to make it more difficult for others to reproduce the stream.

In most embodiments, the rendering step S110 is performed by use of a plurality of software streaming clients comprised in the streaming server. Each software streaming client connects to one of the plurality of available perspective views, such that one available view is rendered by one software streaming client. In most embodiments, the same perspective view is not rendered by two different software streaming clients, i.e. the streaming server comprises only one video per perspective view available.

In a third step S120, match metadata is analyzed in order to determine match events of interest. Typically, match events of interest entails events such as kills, winning rounds, and similar events that are relevant for the outcome of a match. The method starts by analyzing the metadata of a match, which is a more efficient process than analyzing each individual video stream being hosted by the software streaming clients in order to look for match events of interest. The match metadata is typically also located on the game server, and comprises measurable, typically quantifiable, information such as kills, deaths, round wins and other information relevant for the game being played. In some embodiments, the match metadata may be automatically generated, and in some embodiments the match metadata may be automatically generated by the game server. As will be understood, the metadata available will differ depending on the game that is being played. In some embodiments, the match metadata further comprises timestamp data, detailing when the events happen in relation to a match time. Further, each video stream of the plurality of video streams rendered in step 110 may also comprise timestamp data, detailing how the video stream relates to a match time.

After the match metadata has been analyze in order to identify match events of interest, a list of all relevant match events of interest is compiled in a step S130.

After the list of all relevant match events of interest has been compiled, an interest value is assigned to each identified match event of interest in a step S140. In some embodiments, the interest value is also based on match metadata. For example, a match event of interest comprising five kills is likely to be considered more interesting than a match event of interest comprising one kill. A match event of interest comprising one kill that immediately precedes the end of a round is likely to be more interesting than a match event of interest happening at a start of a round. Other types of match metadata may be used to determine the interest value, and the types of match metadata used varies depending on which game is being played. In some embodiments, the interest value is assigned based on the amount of kills present in the match event of interest, such that an event of interest with a higher amount of kills has a higher interest value than an event of interest with a lower amount of kills. In some embodiments, the interest value is assigned such that an event of interest occurring earlier in a match is assigned a higher interest value than an event of interest occurring later in the match. In some embodiments, the interest value is assigned such that an event of interest that occurs later in a match is assigned a higher interest value than an event of interest occurring earlier in the match.

After an interest value has been determined and assigned to each match event of interest, the method comprises a step S150 of determining relevant video segments for each match event of interest. In some embodiments, the step S150 is based on only the match metadata, in some embodiments including the timestamp data that may be included in the match metadata. In such embodiments, the determining step S150 may comprise choosing video segments starting a predetermined time before a match event of interest, and ending a predetermined time after said match event of interest. For example, in case of a kill being a match event of interest, and the kill occurs at 7:02 in match time, the determined relevant video segments could be from 6:42 to 7:12 in match time, for all relevant perspectives.

Which perspectives are considered relevant may in some embodiments also be based on only the match metadata in some embodiments, such that the players involved in an event are determined to represent the relevant perspectives. For example, the player performing a kill, the player being killed, and the players assisting in the kill may be determined as the relevant perspectives for that kill, wherein the kill represents a match event of interest.

In some embodiments, the step S150 may comprise performing visual analysis on each of the plurality of video streams for each identified event of interest, in order to determine if the perspective view of a video stream is relevant to display for a specific identified match event of interest. The analysis may also be based on timestamp data, which makes it possible to only analyze parts of the videos being rendered by the plurality of streaming clients, for each match event of interest. For example, if an event is identified as occurring at 13:43 in match time, it would be unnecessary to analyze the entire video for determining whether a certain perspective view is relevant for the determined match event of interest. Instead, it would be more beneficial to analyze a time interval close to that of the determined time, such as for example between 12:43 and 14:43. The benefits from only analyzing relevant parts of the video are greater than in traditional solutions, considering that there are a plurality of available video streams to analyze, each comprising a different perspective view.

The visual analysis that in some embodiments is performed in step S150 may comprise visual analysis of each video stream for each determined match event of interest, in order to determine if the video stream comprises a relevant video segment for that match event of interest. For example, the perspective view of a player being involved in a kill is likely to be determined as a relevant perspective view. The perspective view of one of that player's teammates may also provide a relevant perspective, even though this player was not directly involved in the kill. The way this is determined is by visual analysis, typically by looking for certain pre-defined criteria, such as if the video representing a perspective view shows any of the persons being directly involved in the match event of interest.

By the combination of analyzing match metadata and then determining relevant video segments based on the match events of interests obtained from analyzing the metadata, a more efficient method is achieved that is more likely to include all perspectives that may be of relevance to a viewer. As described above, certain perspective views, such as player perspective views, may provide relevant and interesting viewpoints for events wherein the player is not involved per se, which would be impossible to locate based only on the match metadata, since there is typically no information in the match metadata that provide information about things such as if an event is visible from a specific player's point of view.

After step S150 has been performed, the streaming server has information about all relevant video segments for each match event of interest, comprising data regarding which parts of each of the plurality of available video streams that are relevant for a particular match event of interest.

The method further comprises a step S160 of providing relevant video segments to a communications device, wherein the step S160 comprises providing at least two relevant video segments for at least one match event of interest. This entails that for each determined match event of interest, the user is provided with video of at least two relevant perspective views, such that the user may view the perspective views simultaneously. As will be understood, the maximum amount of perspective views being provided to a user for any particular match event of interest, is the amount of perspective views available for the particular match being analyzed. In some embodiments, the relevant video segments are provided such that the video segments may be manipulated independently of each other, wherein manipulated denotes that they may be played, fast-forwarded, backed up, stopped, paused, etc.

In some embodiments, the video segments may be provided such that they are synchronized relative to an in-game timer, such that if the video segments are played and started simultaneously they will reflect the same in-game time. An in-game timer may be a timer which indicates for example a time elapsed from the start of a match or the start of a round, or a time remaining until the end of a round or until the end of a match. The method may then also comprise a preceding step of analyzing visual time data in each of the relevant video segments, in order to determine a relationship between an in-game time of a video segment and time metadata related to the same video segment, and providing the video segments such that they are synchronized in relation to the in-game timer, wherein visual time data is visually identifiable data in a video stream or video segment indicative of a game time or in-game timer.

The communications device to which the video segments is provided may be any device capable of streaming video and audio, and is typically a device such as a smartphone, a tablet or a computer.

In some embodiments, the providing step S160 is based on the assigned interest value, such that video segments related to a match event of interest with a high interest value are provided before video segments related to a match event of interest with a lower interest value. In some embodiments, all of the relevant video segments may be provided simultaneously, and in some embodiments, it is possible to provide the video segments with a lower interest value before the video segments with a higher interest value.

In some embodiments, the method may also comprise an intermediate step of bundling the relevant video segments for each match event of interest. After the relevant video segments for each match event of interest has been determined in step S150, the streaming server may package the relevant video segments into a bundle for each match event for interest. In some embodiments, this comprises creating a multi perspective video for each match event of interest, each multi perspective video comprising at least two relevant video segments. However, it may be such that a particular perspective view is relevant during a longer time period for a certain match event of interest than another perspective view. For example, consider that a kill takes place at 1:00 in match time. The perspective of the person being killed may be relevant to watch from 00:45 up until 1:00, whereas the perspective of the person performing the kill may be relevant to watch from 00:50 to 1:10. The server may then create a multi perspective video where the video from one perspective view starts and/or ends before the video from another perspective view. As will be understood, such a multi perspective video comprises multiple different perspectives, wherein each video of a perspective view has a different duration, start time and stop time. In embodiments comprising the bundling step, the bundling is typically based on timestamp data the match events of interest and of the relevant video segments related to the match event of interest. The bundled video provided to the communications device are typically such that the viewer only needs to choose to play the entire bundle, and then the relevant video segments included in the bundle will start and stop depending on their individual start and stop times, in a synchronized manner such that the video segments streamed to the user show are shown with the same relation to a match time.

In embodiments comprising the bundling step, the relevant video segments may be provided to the communications device such that one bundle is provided for each match event of interest, each bundle comprising a multi perspective video as described above.

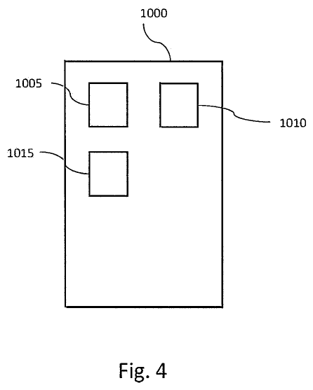

Looking now at FIG. 4, the functional architecture of a streaming server according to the present disclosure will now be described. As described previously, the streaming server 1000 may typically comprises a plurality of software streaming clients, and is typically hosted in a cloud environment. The software streaming clients are adapted for connecting to a game server comprising a plurality of video streams of different perspectives of the esports match.

The streaming server 1000 comprises an encoder 1005 for rendering a plurality of video streams on the software streaming clients of the server. Typically, the rendering comprises connecting to a game server comprising video streams for a match being played, or that has been played, and reproducing these video streams on the streaming server 1000.

The server further comprises a processor 1010, adapted for analyzing match metadata, compiling a list of match events of interest, compiling a list of match events of interest, assigning an interest value to each match event of interest, and for determining relevant video segments for each match event of interest.

The server 1000 further comprises a bundling unit 1015, adapted for bundling video segments related to a same match event of interest together. The bundling unit 1015 is adapted for creating a multi perspective video based on a plurality of single perspective videos. Such multi perspective videos may comprise video segments starting and stopping at different times. This entails that for some time durations the multi perspective video may only comprise a single video being displayed, however a multi perspective video according to the present disclosure will always comprise at least one time period wherein at least two video segments are being displayed simultaneously. When the display of the relevant video segments starts and stops is typically based on the timestamp data, related to the events of interest and/or related to the determined relevant video segments and/or related to the plurality of video streams.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the_art, and that the scope of the presently described concept is accordingly not to be limited. Reference to an element in the singular is not intended to mean “one and only one” unless explicitly so stated, but rather “one or more”. Moreover, it is not necessary for an apparatus or method to address each and every problem sought to be solved by the presently described concept, for it to be encompassed hereby.

1. A method performed by a streaming server of a communications network for providing highlights of an esports match from a server to a communications device, the server comprising a plurality of software streaming clients, wherein the method comprises:
connecting (S100) to a game server, the game server comprising match metadata and a plurality of video streams of different perspectives of the esports match;
rendering (S110) the plurality of video streams from the game server, wherein each software streaming client renders a different video stream;
analyzing (S120) the match metadata in order to find match events of interest in the esports match;
compiling (S130) a list of match events of interest;
assigning (S140) an interest value to each match event of interest in the complied list;
determining (S150) relevant video segments of the video streams for each match event of interest;
providing (S160) the relevant video segments to the communications device, wherein the providing comprises providing at least two relevant video segments for at least one match event of interest.

2. The method according to claim 1, wherein the determining step (S150) is based on the match metadata.

3. The method according to claim 1, wherein each event of interest comprises timestamp data, each relevant video segment comprises timestamp data, and wherein the determining step (S150) is based on the timestamp data.

4. The method according to claim 1, further comprising a step of bundling the relevant video segments before providing them to the communications device.

5. A streaming server for providing highlights of an esports match to a communications device, the server comprising:
a plurality of software streaming clients for connecting to a game server comprising a plurality of video streams for the esports match and match metadata;
an encoder (1005) for rendering the plurality of video streams on the plurality of software streaming clients;
a processor (1010), adapted for:
analyzing the match metadata in order to find match events of interest in the esports match;
compiling a list of match events of interest;
assigning an interest value to each match event of interest in the complied list;
determining relevant video segments of the video streams for each match event of interest;
providing the relevant video segments to the communications device, wherein the providing comprises providing at least two relevant video segments for at least one match event of interest.

6. The streaming server according to claim 5, further comprising:
a bundling unit (1015) adapted for bundling video segments related to a same match event of interest together.

7. The streaming server according to claim 5, wherein the determining is based on the match metadata.

8. The streaming server according to claim 5, wherein each event of interest comprises timestamp data, each relevant video segment comprises timestamp data, and wherein the determining step is based on the timestamp data.
